(19) United States
(12) Patent Application Publication
(10) Pub. No.: US 2022/0211075 A1
(43) Pub. Date: Jul. 7, 2022

(54) DIGESTION OF FORAGE CONTAINING LIGNOCELLULOSE WITH FIBROLYTIC ENZYMES AND RECOMBINANT BACTERIAL EXPANSINS

(71) Applicant: UNIVERSITY OF FLORIDA RESEARCH FOUNDATION, INCORPORATED, GAINESVILLE, FL (US)

(72) Inventors: Adegbola Tolulope ADESOGAN, Gainesville, FL (US); Claudio F. GONZALEZ, Gainesville, FL (US); Diwakar VYAS, Gainesville, FL (US); Andres Alfredo PECH CERVANTES, Gainesville, FL (US)

(21) Appl. No.: 17/611,316

(22) PCT Filed: May 15, 2020
(86) PCT No.: PCT/US2020/033055

§ 371 Date: Nov. 15, 2021

Related U.S. Application Data
(60) Provisional application No. 62/848,207, filed on May 15, 2019.

(51) Int. Cl. A23K 10/30; A23K 10/14; A23K 50/10; A23K 20/189

(52) U.S. Cl. CPC A23K 10/30; A23K 20/189; A23K 50/10; A23K 10/14

(57) ABSTRACT

Studies on a recombinant bacterial expansin-like protein from Bacillus subtilis (BsEXLXt) and a commercial exogenous fibrolytic enzyme (EFE) preparation for ruminants on the hydrolysis of pure substrates (cellulose and xylan) and in vitro digestibility of bermudagrass haylage have shown that, compared to EFE alone, EFE and BsEXLXt synergistically increased sugar release from carboxymethylcellulose and filter paper. Therefore, a combination of EFE and an expansin-like protein is useful to improve the hydrolysis of cellulose-containing substrates and the hydrolysis and digestibility of forage in vitro.

### BACKGROUND

### 1. Field

The invention relates to methods for improving the digestibility of forage used as ruminant feed, particularly such material that contains lignocellulose, which renders the material more difficult to digest.

### 2. Background

In the tropics and subtropics, the digestibility of forages used to supply energy and effective fiber to dairy cows is low. Therefore, increasing their digestibility has been the goal of several studies investigating whether exogenous fibrolytic enzymes (EFE) can be used to increase forage digestibility. The results of such studies have been largely inconsistent. Among the reasons for this, the efficacy of EFE is dependent on accessibility to the substrate.

Ruminants are mammals that are able to acquire nutrients from plant-based food containing cellulose by fermenting it in a specialized stomach (rumen) prior to digestion, principally through microbial actions. Ruminants include both domestic and wild species, such as bovines, goats, sheep, giraffes, deer, gazelles, and antelopes.

Cellulose and hemicellulose are highly organized structures in plants, however the presence of lignin in forage biomass results in lignocellulose, an intricate and recalcitrant network, which impedes access to digestible fiber in the cell wall. Previous research shown that enzymatic hydrolysis of lignocellulose into fermentable sugars is inherently difficult because the process is hindered by factors like accessibility as well as porosity, particle size, and limited surface area.

Cellulose is an organic polysaccharide consisting of a linear chain of several hundred to many thousands of β(1→4) linked D-glucose units. Cellulose is an important structural component of the primary cell wall of green plants, many forms of algae, and the oomycetes. Some species of bacteria secrete it to form biofilms. Cellulose is mainly used to produce paperboard and paper or other products such as cellophane and rayon. Conversion of cellulose from energy crops into biofuels such as cellulosic ethanol is under development as a renewable fuel source.

Hemicelluloses are branched polysaccharides related to cellulose that comprise about 20% of the biomass of land plants. In contrast to cellulose, hemicelluloses are derived from several sugars in addition to glucose, especially xylose but also including mannose, galactose, rhamnose, and arabinose. Hemicelluloses generally consist of shorter chains, between 500 and 3000 sugar monomers.

Cellulose breakdown is of considerable economic importance, because it can enable consumption of the plants by humans and by animals, and the use of many plants and plant products in chemical reactions and industry. Cellulase is used for commercial food processing in coffee, for example, and in the drying of beans. Cellulases also are widely used in the textile industry, in the pulp and paper industry, and in detergents and pharmaceuticals. An important use of cellulase is used the fermentation of biomass into biofuels, although this process is relatively experimental at present due to lack of efficiency.

Therefore, there is a need in the art to discover more efficient methods to increase digestibility of forage containing lignocellulose, both for animal feed purposes and for production of biofuel.

### SUMMARY

Therefore, the effects of a recombinant bacterial expansin-like protein (BsEXLX1) and EFE on hydrolysis of pure cellulose and hemicellulose, simulated post-ingestive hydrolysis and digestibility in vitro of bermudagrass haylage (BMH), and simulated preingestive hydrolysis and profile of sugars released from BMH. Additionally, similar loosenin or expansin-like proteins to BsEXLX1 (from ruminal bacterial genomes) were investigated. Synergistic effects between BsEXLX1 and EFE increased hydrolysis of cellulose and hemicellulose-based pure substrates and increase simulated pre and post-ingestive hydrolysis and in vitro digestibility of bermudagrass haylage. In summary, this study has shown that adding EFE with BsEXLX1 synergistically increased hydrolyses of pure cellulose but not xylan, and increased simulated pre- and post-ingestive hydrolysis and digestibility in vitro of ADF and NDF of BMH.

In particular, the invention relates to a method of increasing the digestibility of forage for animal feed, comprising contacting the forage with an exogenous fibrolytic enzyme and an expansin-like protein.

### BRIEF SUMMARY OF THE DRAWINGS

FIG. 1 is a set of microphotographs of cotton cell walls in phase contrast (FIG. 1A and

FIG. 1C) and immunofluorescence (FIG. 1B and FIG. 1D) under the indicated control and BsEXLX1 exposure conditions.

FIG. 2 is a photograph of SDS-PAGE (12% w/w) of the purified recombinant bacterial expansin (BsEXLX1) from Bacillus subtilis.

FIG. 3 is a bar graph showing data of sugar released by cells by cellulase, with and without BsEXLX1 at the indicated times.

### DETAILED DESCRIPTION

### 1. Definitions

Unless defined otherwise, all technical and scientific terms used herein have the same meaning as commonly understood by one of ordinary skill in the art. Although various methods and materials similar or equivalent to those described herein can be used in the practice or testing of the present invention, suitable methods and materials are described below. However, the skilled artisan understands that the methods and materials used and described are examples and may not be the only ones suitable for use in the invention. Moreover, as measurements are subject to inherent variability, any temperature, weight, volume, time interval, pH, salinity, molarity or molality, range, concentration and any other measurements, quantities or numerical expressions given herein are intended to be approximate and not exact or critical figures unless expressly stated to the contrary.

As used herein, the term “about” means plus or minus 20 percent of the recited value, so that, for example, “about 0.125” means 0.125±0.025, and “about 1.0” means 1.0±0.20.

As used herein, the term “forage” refers to any plant material eaten by grazing livestock, particularly ruminants. “Silage” refers to any grass or other green fodder stored for use as animal feed. “Haylage” refers to such grass or other green fodder that has been partially dried, and is a type of silage.

As used herein, the term “expansin” refers to a family of closely related nonenzymatic proteins found in the plant cell wall, with important roles in plant cell growth, fruit softening, abscission, emergence of root hairs, pollen tube invasion of the stigma and style, meristem function, and other developmental processes where cell wall loosening occurs. The term “expansin-like protein” refers to expansins of microbial origin. “BsEXLX” refers to a recombinant expansin-like protein isolated from the Bacillus subtilus strain UD1022 gene, systematically annotated as yoaJ (accession number WP_015383820.1). Examples of other expansin sequences include those found in accession numbers WP_014114004.1; WP_015251956.1; CP002905.1; KMN96517.1; and QGI00928.1.

As used herein, the term “exogenous fibrolytic enzyme (EFE)” refers to commercial fiber degrading enzymes used for improving fiber digestibility in ruminant diets. Examples EFEs include but are not limited to cellulase, ligninase, beta-glucosidase, hemicellulase, xylanase, alpha amylase, amyloglucosidase, pectate lyase, cutinase, lipase, keratinase, maltogenic alpha-amylase, and pectolyase. In a specific example, the EFE pertains to cellulase or hemicellulase.

As used herein, the term “preingestive hydrolysis” refers to the rate and extent of fiber hydrolysis before ingestion.

As used herein, the term “cellulase” refers to any of several enzymes produced chiefly by fungi, bacteria, and protozoans that catalyze the decomposition of cellulose, and also is used for any naturally occurring mixture or complex of various such enzymes that decompose cellulosic material into monosaccharides or shorter polysaccharides and oligosaccharides.

As used herein, the term “ruminant” refers to any of the domestic and wild species of animals, such as bovines, goats, sheep, giraffes, deer, gazelles, and antelopes, that digest cellulosic plant material by fermentation of in a specialized rumen.

### 2. Overview

Expansins and expansin-like proteins are non-hydrolytic proteins that facilitate loosening and hydrolysis of lignocellulose by fibrolytic enzymes. However, no studies have examined if expansin-like proteins can improve the efficacy of commercial fibrolytic enzymes at improving fiber hydrolysis and digestion in diets or forages fed to dairy cows and other ruminants. Here, synergistic effects between expansin-like proteins and fibrolytic enzymes resulted in increasing fiber hydrolysis, although results are substrate-dependent. The effects of a recombinant bacterial expansin (BsEXLX1) protein from Bacillus subtilis and a fibrolytic enzyme on hydrolysis of pure cellulose substrates and in vitro digestibility of bermudagrass haylage were studied. Applying both EFE and BsEXLX1 synergistically increased hydrolysis of purified cellulose and increased digestibility of bermudagrass haylage.

### 3. Summary of Results

Synergistic effects between EFE and a recombinant bacterial expansin (BsEXLX1) increased hydrolysis of cellulose but not xylan. In addition, EFE and BsEXLX1 synergistically increased simulated pre- and post-ingestive hydrolysis, in vitro digestibility and rumen-like fermentation of neutral detergent fiber (NDF) and acid detergent fiber (ADF) of bermudagrass haylage. The preingestive hydrolysis assay showed that synergistic effects between EFE and BsEXLX1 increased cellobiose concentration by 72% compared to the EFE alone but did not affect glucose or xylose concentrations.

### 4. Exemplary Embodiments

Non-hydrolytic proteins such as expansins and expansin-like proteins facilitate loosening and hydrolysis of lignocellulose by fibrolytic enzymes. Thus, synergistic effects of cellulases, hemicellulases and expansins or expansin-like proteins have been examined to increase hydrolysis of cellulose and hemicellulose for bioethanol production. However, no studies have examined if expansin-like proteins can improve the efficacy of exogenous fibrolytic enzymes at improving fiber hydrolysis and digestion in diets or forages fed to dairy cows and other ruminants. Expansin-like protein BsEXLX1 is a chaotropic agent that can disrupt cellulose chains without detectable hydrolysis. Synergistic effects between cellulase and recombinant bacterial expansin-like proteins, including BsEXLX1 from Bacillus subtilis, increased degradation of cellulose by over 100% compared to cellulase alone.

### Substrates

Ruminant production systems throughout the world are based on forages. Forages have substantial content of cell walls and are suited for utilization by herbivores because of their capability of microbial digestion of cell wall constituents. Expansin-like proteins have potential to improve fiber digestibility from forages commonly used for ruminant production system such as corn silage, bermudagrass haylage, bermudagrass hay, alfalfa silage, alfalfa hay, and the like.

### Aids to Synergistic Cellulose Hydrolysis

Fibrolytic enzyme supplements are used to improve the nutritive value of feeds for ruminants. However, improvement in production performance both in dairy cows and beef cattle with fibrolytic enzymes are inconsistent. Hence, there is need to improve the efficacy of commercial fibrolytic enzymes. The results from our experiments have shown that the efficacy of commercial fibrolytic enzymes can be improved when provided in combination with expansin-like proteins isolated from Bacillus subtilis.

Improvement in fiber hydrolysis can have greater impact on production performance of animals. For example: for a one percent increase in fiber digestibility, there is a 0.37 lb increase in intake levels resulting in 0.55 lbs of increase in milk yield from lactating dairy cows. The economic impact of improved digestibility is huge taking into account the intake levels of each cow (20-30 kg/d), the number of cows (more than 1000), and average milk production (40-50 kg/d) at larger dairy farms. Hence, minor differences in fiber digestibility or dry matter digestibility can have huge impacts on profitability considering the scale at which forages are used for the dairy industry.

Synergistic effects indicates that with the effects on nutrient digestibility with the combination of commercial fibrolytic enzymes and expansin-like proteins will be greater than the sum of individual effects. The use of the term synergistic throughout this document indicates that the interaction between fibrolytic enzymes and expansin-like protein was statistically significant and effects were greater than additive effects of fibrolytic enzymes and expansin-like proteins. Significance was declared at 5% level of significance which implies that despite taking into account variability in the experimental results using natural products, we are 95% confident that our results are correct and if repeated we will observed similar significant results.

### Methods of Use and Compositions

The use of expansin-like proteins with fibrolytic enzymes (e.g. cellulose-degrading enzymes) were proposed earlier for conversion of cellulosic biomass into biomass. It has been discovered that the combination of expansin-like proteins with commercial EFE can be used to improve fiber digestibility of forages or feeds used for ruminant diets. In an embodiment, provided is a method of increasing the digestibility of forage for animal feed, comprising contacting the forage with an exogenous fibrolytic enzyme (EFE) and an expansin-like protein.

In another embodiment, compositions are provided that include an amount of at least one EFE and at least on expansin-like protein. The composition may optionally further be formulated with a botanically acceptable carrier. As used herein, a “botanically acceptable vehicle or carrier”, is preferably a liquid, aqueous vehicle or carrier such as water. The composition may be formulated as an emulsifiable concentrate(s), suspension concentrate(s), directly sprayable or dilutable solution(s), coatable paste(s), dilute emulsion(s), wettable powder(s), soluble powder(s), dispersible powder(s), dust(s), granule(s) or capsule(s).

The compositions may optionally include a botanically acceptable carrier that contains or is blended with additional inert ingredients. Inert ingredients which can be included in the carrier formulation can be selected from any compounds to aid in the physical or chemical properties of the composition. Such inert ingredients can be selected from buffers, salts, ions bulking agents, colorants, pigments, dyes, fillers, wetting agents, dispersants, emulsifiers, penetrants, preservatives, antifreezes, evaporation inhibitors, bacterial nutrient compounds, anti-caking agents, defoamers, antioxidants, and the like.

### SEQUENCES

Provided below is an amino acid sequence of exemplary expansin-like protein.

| (SEQ ID NO: 3) | |
|---|---|
| 1 | MKKLMSAFVG MVLLTIFCFS PQASAAYDDL HEGYATYTGS GYSGGAFLLD PIPSDMEITA |
| 61 | INPADLNYGG VKAALAGSYL EVEGPKGKTT VYVTDLYPEG ARGALDLSPN AFRKIGNMKD |
| 121 | GKINIKWRVV KAPITGNFTY RIKEGSSRWW AAIQVRNHKY PVMKMEYEKD GKWINMEKMD |
| 181 | YNHFVSTNLG TGSLKVKMTD IRGKVVKDTI PKLPESGTSK AYTVPGHVQF PE |

Examples of expansin-like proteins include those having expansin activity and at least 80%, 85%, 90%, 91%, 92%, 93%, 94%, 95%, 96%, 97%, 98% or 99% sequence identity to the amino acid sequence of SEQ ID NO: 3. The term “sequence identity” or “identity,” as used herein in the context of two polynucleotides or polypeptides, refers to the residues in the sequences of the two molecules that are the same when aligned for maximum correspondence over a specified comparison window. As used herein, the term “percentage of sequence identity” or “% sequence identity” refers to the value determined by comparing two optimally aligned sequences (e.g., nucleic acid sequences or polypeptide sequences) of a molecule over a comparison window, wherein the portion of the sequence in the comparison window may comprise additions or deletions (i.e., gaps) as compared to the reference sequence (which does not comprise additions or deletions) for optimal alignment of the two sequences. The percentage is calculated by determining the number of positions at which the identical nucleotide or amino acid residue occurs in both sequences to yield the number of matched positions, dividing the number of matched positions by the total number of positions in the comparison window, and multiplying the result by 100 to yield the percentage of sequence identity. A sequence that is identical at every position in comparison to a reference sequence is said to be 100% identical to the reference sequence, and vice-versa.

Other embodiments relate to expansin-like proteins having at least 80%, 85%, 90%, 91%, 92%, 93%, 94%, 95%, 96%, 97%, 98%, 99% or 100% sequence identity to the amino acid sequences provided in accession numbers WP_014114004.1; WP_015251956.1; CP002905.1; KMN96517.1; and QGI00928.1.

### 5. Examples

This invention is not limited to the particular processes, compositions, or methodologies described, as these may vary. The terminology used in the description is for the purpose of describing the particular versions or embodiments only, and is not intended to limit the scope of the present invention which will be limited only by the appended claims. Although any methods and materials similar or equivalent to those described herein can be used in the practice or testing of embodiments of the present invention, the preferred methods, devices, and materials are now described. All publications mentioned herein, are incorporated by reference in their entirety; nothing herein is to be construed as an admission that the invention is not entitled to antedate such disclosure by virtue of prior invention.

### Example 1. Disruptive Activity of BsEXLX on Cotton Fibers

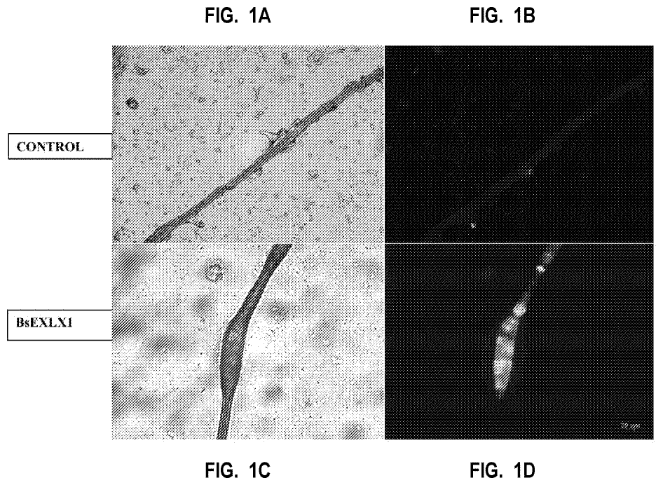

In order to verify the disruptive activity of BsEXLX1 (162 μg/g) and control (buffer only), 20 mg cotton fibers were incubated in triplicate for 1 hour at pH 4 and 50° C. Cell wall extension was measured and immunofluorescence was used to localize BsEXLX1. On average, BsEXLX1 expanded the diameter of cotton fiber cell walls by 30% (P<0.01) compared with the control, and immunofluorescence confirmed the expansion was due to BsEXLX1 (see FIG. 1).

### Example 2. Protein Purification and Initial Validation of Synergy with Cellulase

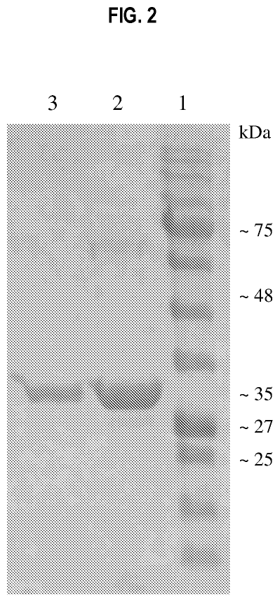

To express and purify a novel bacterial expansin-like protein from Bacillus subtilis (BsEXLX1), the extraction, cloning, purification and functional characterization of BsEXLX1 was performed based on methods published earlier (Cervantes et al., 2016). Briefly, the amplified DNA fragment (BsEXLX1 gene) was cloned into a p15TV-LIC plasmid and inserted into E. coli BL21-Star (Life Technologies™, Grand Island, N.Y., USA). Bacterial cells were grown with shaking in Luria-Bertani medium (LB) at 37° C. under aerobic conditions with 2.5 mM betaine and 1 M sorbitol (40 L). Bacterial growth was induced using isopropyl β-D-1-thiogalactopyranoside (IPTG) at an optical density (OD) of 600 nm=0.5 and incubated at 17° C. overnight. The cells were centrifuged at 7600×g 4° C. for 15 minutes, and the pellet was suspended in binding buffer (500 mM sodium chloride, 5% glycerol, 50 mM Tris pH 8.0, 5 mM imidazole, and 0.5 mM Tris (2-chloroethyl) phosphate (TCEP), after which cells were lysed by passing them through a French press (ThermoFisher Scientific™, Massachusetts, USA). The lysed cells were centrifuged at 14,100×g for 30 minutes at 4° C., then, the cell-free extract was added into a metal chelate affinity-column charged with Ni²⁺ (Qiagen™, USA). The eluted proteins were dialyzed, and protein concentration was determined using a protein assay kit (Bio-Rad™, Hercules, Calif., USA). Protein purity was confirmed using SDS-PAGE gel stained with Coomassie-blue. See FIG. 2.

Typically, BsEXLX1 is low molecular weight protein, about 25-27 kDa and this study has confirmed this based on SDS-PAGE data. FIG. 2 shows a photograph of SDS-PAGE. Lane 1: Molecular ladder; Lane 2: BsEXLX1 protein prior to dialysis; Lane 3; BsEXLX1 protein after dialysis.

Primers were constructed based on the Expansin-Yoaj protein sequence (accession number: WP_015383820.1) and tested using genomic DNA from Bacillus subtilis strain, UD1022. The plasmid p15TV-LdtR was used as template and transformed in E. coli DH5-a. Briefly, the primers

F-
(SEQ ID NO: 1)
5′ttgtatttccagggcatgagtgcatttgttggtatgg 3′
and
R-
(SEQ ID NO: 2)
5′caagcttcgtcatcattattcaggaaactgaacatggcc 3′

were used to amplify the bacterial expansin gene (yoaJ gene) using genomic DNA from Bacillus subtilis UD1022. Standard methods were used for chromosomal DNA isolation, restriction enzyme digestion, ligation, transformation, and agarose gel electrophoresis. DNA extraction, isolation and digestion methods described by Sambrook et al. (1989) were used. Bacterial transformation and protein purification were performed according to Pagliai et al. (2015). The His-tagged fusion proteins in the plasmid were overexpressed in E. coli BL21-Star (DE3) cells. Then the cells were lysed using a French Press and purified with a metal chelate affinity-column charged with Ni2+. The remaining fraction was dialyzed, then protein concentration and molecular weight were determined. Protein identity was confirmed by sequencing and using Phyre2 software.

In order to confirm the presence and activity of BsEXLX1 and synergy with cellulases, an experiment was conducted using a commercial purified cellulase from Trichoderma reseei (Sigma-Aldrich™, Saint Louis, USA). Fresh purified protein BsEXLX1 (0.4 mg/g substrate less than 1 hour after purification) and cellulase (0.4 mg/g of substrate) were added to Avicel™ (10 mg/mL) (Sigma-Aldrich™, Saint Louis, USA) substrate and incubated in citrate buffer at pH 4 and 50° C. for 3 and 12 hours. Sugar release was measured using the 3,5-dinitrosalicylic acid (DNS) method according to Miller (1959). This experiment confirmed the activity of the protein prior to continuing with subsequent experiments.

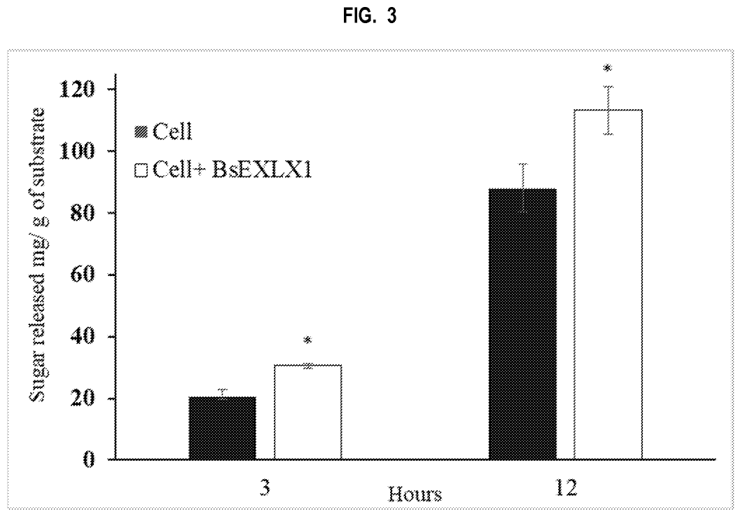

Combining BsEXLX1 and cellulase synergistically increased (P<0.05) reducing sugar release from Avicel™ compared to cellulase alone by 48.3% after 3 hours and 28.8% after 12 hours (FIG. 3). FIG. 3 shows the synergistic effects between freshly purified BsEXLX1 and cellulase on Avicel™ under optimum conditions for the expansin (pH 4 and 50° C.). Error bars indicate standard deviation of the mean. * indicates significant differences (P<0.05).

Recombinant expansins and expansin-like proteins can improve the hydrolysis of cellulose because of their high affinity even at low concentrations of cellulose. The cellulase-BsEXLX1 ratio plays a role in synergistic effects because BsEXLX1 and cellulase compete for binding sites when both are dosed at high concentrations.

Thus, in summary, expansin-like protein expands the cell wall of cotton fiber (pure cellulose), confirmed using immunofluorescence techniques. Pure BsEXLX1 showed synergistic activity with pure cellulase.

### Example 3. Effects of BsEXLS1 and EFE

Three separate experiments were conducted to examine the effects of a recombinant bacterial expansin-like protein (BsEXLX1) from Bacillus subtilis and a commercial exogenous fibrolytic enzyme (EFE; Xylanase Plus, Dyadic International, Jupiter, Fla.) preparation for ruminants on hydrolysis of pure substrates (cellulose and xylan) and in vitro digestibility of bermudagrass haylage (BMH).

In Experiment 1, carboxymethylcellulose (CMC), Whatman paper #1 (FP, composed of cellulose) and oat-spelt xylan (composed of xylose, the backbone of hemicellulose) were used as pure substrates for testing. Substrates were subjected to four treatments:

1) Sodium citrate buffer (control),

2) BsEXLX1 (162 μg/g substrate),

3) EFE (2.3 mg/g substrate), and

4) EFE+BsELX1.

Synergistic effects of BsEXLX1 and EFE were examined with a 24-hour enzymatic hydrolysis assay in vitro. Samples were incubated at optimal conditions for both additives (pH 5 and 50° C.) or at ruminal (pH 6 and 39° C.) or ambient (pH 6 and 25° C.) conditions for 24 hours and sugar release was measured. Cellulose and xylan are composed of sugars and measuring sugar release is an indirect indicator of cellulose and xylan hydrolysis.

Addition of BsEXLX1 synergistically increased hydrolysis of crystalline (CMC) and insoluble (filter paper) cellulose (P<0.01) by the EFE under optimal conditions for the additives as well as under ruminal conditions for dairy cows and at ambient temperature (see Table 1, below). After 24 hours of incubation, BsEXLX1 synergistically increased (P<0.01) hydrolysis of CMC by EFE by 6.7, 8.7 and 7% under the respective conditions. Notably, hydrolysis of filter paper by EFE was synergistically increased (P<0.01) by 33.3% by BsEXLX1 under ruminal conditions, suggesting that the synergy was greater for insoluble versus crystalline cellulose. See Table 1, below. BsEXLX1 has a high binding capacity towards insoluble cellulose because its loosening ability requires a hydrophobic surface to promote electrostatic interactions with fiber, possibly explaining why the synergistic effects were remarkably higher in filter paper compared to CMC.

TABLE 1
Effect of BsEXLX1 and EFE on Cellulose and Hemicellulose-based Pure Substrates.

| BsEXLX1 | | | | | | | | |
|---|---|---|---|---|---|---|---|---|
| (μg/g | Control¹ | | EFE¹ | | | P- value | | |
| substrate) | 0 | 162 | 0 | 162 | SEM | EFE | BsEXLX1 | Interaction |
| CMC^{O} | 4.0^{c} | 4.1^{c} | 46.1^{b} | 49.2^{a} | 0.3 | <0.01 | <0.01 | <0.01 |
| CMC^{R} | 4.1^{c} | 3.6^{c} | 38.8^{b} | 42.2^{a} | 0.4 | <0.01 | <0.01 | <0.01 |
| CMC^{A} | 3.8^{c} | 3.6^{c} | 37.1^{b} | 39.7^{a} | 0.5 | <0.01 | 0.04 | 0.01 |
| Filter | 1.3^{c} | 1.3^{c} | 5.7^{b} | 7.6^{a} | 0.1 | <0.01 | <0.01 | <0.01 |
| paper^{R} | | | | | | | | |
| Xylan^{O} | 5.8^{b} | 6.2^{b} | 119^{a} | 123^{a} | 1.3 | <0.01 | 0.06 | 0.11 |
| Xylan^{R} | 61^{b} | 6.3^{b} | 139^{a} | 137^{a} | 0.8 | <0.01 | 0.30 | 0.30 |

¹= Sugar released (mg/g of substrate);
^{O}= Optimum conditions (pH 4 and 50° C.);
^{R}= Rumen conditions (pH 6 and 39° C.);
^{A}= Ambient conditions (pH 6 and 25° C.);
Different lower case letters in the same row indicate significant differences (P <0.05); n = 3.

Hydrolysis of xylan by the EFE was almost three times greater than that of cellulose because xylanase activity comprised more than 90% of the activity of the EFE (see Table 2, below). However, hydrolysis of xylan without EFE was not affected by BsEXLX1 (Table 1), indicating that synergy between BsEXLX1 and EFE only occurs in cellulose-based substrates and the non-hydrolytic activity of BsEXLX1. Furthermore, no synergistic increase in fiber hydrolysis of oat-spelt xylan was evident when BsEXLX1 was added to the EFE.

In summary, synergistic effects were evident between BsEXLX1 and EFE on the cellulose based substrates while no synergy was observed when xylan was used as substrate.

In Experiments 2 and 3 Tifton-85 bermudagrass haylage (Cynodon dactylon) (BMH) was used as the substrate. It is widely used as a digestible fiber and energy source in the diet of dairy cows. Representative samples of bermudagrass haylage were cored from 500 kg bales, dried at 60° C. for 48 hours, and ground to pass through the 1-mm screen of a Wiley™ mill. The organic matter (OM), crude protein (CP), neutral detergent fiber (NDF), acid detergent fiber (ADF) and hemicellulose concentrations (dry matter (DM) basis) of the haylage were 93.2, 15.2, 69.2, 36.4, and 32.8%, respectively, and the DM concentration was 35%. Synergistic effects between EFE and BsEXLX1 on BMH were examined using pre-ingestive hydrolysis (Experiment 2) and a 24-hour in vitro ruminal digestibility assay (Experiment 3) (see Goering and Van Soest, 1970).

For pre-ingestive hydrolysis, dried, ground BMH (0.5 g) was treated with 50 μL of citrate buffer (Control) or buffer+BsEXLX1 (162 μg/g of BMH) or buffer with EFE (2.3 mg/g of B+MH) or buffer with the combination of EFE and BsEXLX. Samples were incubated in quadruplicate in three independent runs using polypropylene tubes sealed with a rubber stopper containing a one-way gas release valve. The mixtures were incubated at 25° C. for 1 hour to study the pre-ingestive interaction between the additives and substrate.

In order to estimate the synergistic effects of BsEXLX1 and EFE on BMH fiber hydrolysis, the previous test was repeated without ruminal fluid addition. Samples were incubated for 24 hours at 25° C. in two runs. Treatments and analytical procedures were identical to those in Example 4, except that samples were incubated in 50-mL tubes without ruminal fluid, and sodium azide (0.02% wt/vol) was added to prevent microbial growth. Blanks were included to correct for effects of EFE and BsEXLX1 and the substrate. After incubation, 30 mL of double distilled water was added to the mixture and the suspension was shaken for 1 hour at 9× g using a Thermos Forma™ 420 Incubator Shaker (ThermoFisher™). Tubes were filtered using a previously dried 125-mm Whatman 451 filter paper (Fisher Scientific™) in conical funnels.

Residues were dried at 60° C. for 48 hours and analyzed for DM, NDF, HEM and ADF hydrolysis and reducing sugars using the DNS method previously described. Filtrate samples were frozen (−20° C.) for sugar analysis. Thawed samples were analyzed for cellobiose, glucose and xylose concentrations by HPLC (Hitachi™, L2400) using an HPX-87P column (Bio-Rad Laboratories™) equipped with a refractive index detector. Deionized water was used as the mobile phase following the procedure described by Bach-Knudsen and Li, J. Agric. Food Chem. 39:689-694, 1991. Briefly, samples were filtered using a Sep-Pak™ c18 columns (Waters™ MA, USA) then samples aliquots were mixed with ethanol in a 1:1 ratio, samples were incubated at −20° C. for 30 minutes and subjected to centrifugation for 20 minutes. The supernatant was removed, and the pellet was subjected to dry nitrogen gas for 2 hours at 50° C. and finally suspended in deionized water.

Effects of EFE and BsEXLX1 on preingestive hydrolysis and the sugar profiles of BMH are summarized in Table 2, below. Addition of BsEXLX1 alone did not improve hydrolysis of BMH, further confirming the non-hydrolytic nature of the expansin-like protein. However, adding BsEXLX1 with EFE synergistically increased (P<0.05), hydrolysis of DM, NDF and ADF by EFE by 5.4%, 55% and 128% compared to EFE alone, supporting the results seen in the Examples above using pure substrates.

Reducing sugar concentrations were synergistically increased by adding EFE and BsEXLX1 (P<0.05) by 9.3% versus EFE alone but adding BsEXLX1 alone had no effect (P=0.91). The latter results confirm the non-hydrolytic nature of BsEXLX1. Individual sugar analysis revealed that cellobiose concentrations were synergistically increased by 72.5% by adding EFE and BsEXLX1 (P<0.05) instead of EFE alone. Increases in cellobiose concentrations by EFE and BsEXLX1 suggest that cellobiohydrolases in EFE and BsEXLX1 synergistically cleaved cellulose end-chains to release cellobiose, which can be fermented into organic acids by dominant non-cellulolytic ruminal bacteria like Prevotella spp.

Glucose and xylose concentrations were not affected by adding BsEXLX1 with EFE or BsEXLX1 alone but adding the EFE alone increased (P<0.01) concentrations of these sugars by 240 and 86.2% respectively. Among all cultivars used in the southeast of United States, Tifton 85 has the highest hemicellulose concentration, and xyloglucans in hemicellulose typically contains glucose and xylose in an approximate 4:3 ratio. In this study, hydrolysis of hemicellulose was considerably increased by the EFE but not BsEXLX1, and no synergistic increase in concentrations of the individual sugars was evident by combining the additives. Despite the lack of effects of BsEXLX1 on glucose and xylose, EFE and BsEXLX1 tended to increase glucose:xylose ratio (P=0.07). These results imply that synergistic hydrolysis favored release of hexoses from cellulose over pentoses from hemicellulose.

TABLE 2
Effect of BsEXLX1 and EFE on Hydrolysis of DM, NDF, ADF and Hemicellulose, and
Release of Reducing Sugars, Cellobiose, Glucose and Xylose after Preingestive Hydrolysis of
Bermudagrass Haylage.

| BsEXLX1 (μg/g of | Control | | EFE | | | P-Value | | |
|---|---|---|---|---|---|---|---|---|
| DM) | 0 | 162 | 0 | 162 | SEM | EFE | BsEXLX1 | Interaction |
| Hydrolysis of DM % | 18.5^{c} | 18.5^{c} | 20.1^{b} | 21.2^{a} | 0.2 | <0.01 | 0.03 | 0.02 |
| Hydrolysis of NDF % | 2.5^{bc} | 1.9^{c} | 5.2^{b} | 8.1^{a} | 0.6 | <0.01 | 0.11 | 0.01 |
| Hydrolysis of HEM % | 1.8 | 0.8 | 3.2 | 3.4 | 0.8 | 0.02 | 0.61 | 0.45 |
| Hydrolysis of ADF % | 0.6^{c} | 1.1^{c} | 2.1^{b} | 4.8^{a} | 0.4 | <0.01 | <0.01 | 0.02 |
| Reducing sugars mg/g | 76.1^{c} | 65.5^{d} | 108^{b} | 118^{a} | 5.0 | <0.01 | 0.91 | <0.01 |
| Cellobiose mg/ml | 0 | 0 | 1.02^{b} | 1.76^{a} | 0.06 | <0.01 | <0.01 | <0.01 |
| Glucose (G) | 2.11 | 1.91 | 7.20 | 8.13 | 0.56 | <0.01 | 0.41 | 0.21 |
| mg/ml | | | | | | | | |
| Xylose (X) | 3.46 | 4.46 | 6.44 | 7.85 | 0.62 | <0.01 | 0.02 | 0.68 |
| mg/ml | | | | | | | | |
| G:X ratio | 0.64 | 0.43 | 1.04 | 1.12 | 0.03 | <0.01 | <0.01 | 0.07 |

Different letters in the same row indicate significant differences (P <0.05); N = 2.

For in-vitro ruminal digestibility, ruminal fluid was collected from 2 mature non-lactating, non-pregnant cannulated Holstein dairy cows at approximately 3 hours after feeding. The collection procedure was approved by the University of Florida Institutional Animal Research Committee. After collection, ruminal fluid was filtered through 4 layers of cheesecloth, gassed with CO2 and mixed with the buffer (Goering and Van Soest, 1970) and 52 mL of buffered-ruminal fluid was added to each tube. Treatments used were similar to the ones used for preingestive hydrolysis. The suspension was immediately incubated for 24 hours at 39° C. After 24 hours, tubes were placed in ice to stop the fermentation. Tube contents were filtered under gravity using previously dried (60° C. for 48 hours) and weighed 125-mm Whatman #451 paper (Fisher Scientific, Pittsburgh, Pa.) in conical funnels. Residue samples were oven-dried at 60° C. for 48 hours and weighed to estimate digestibility of DM. Dried residues were sequentially analyzed for neutral detergent fiber (NDF) and acid detergent fiber (ADF) (Van Soest et al., 1991) using an Ankom 200 Fiber Analyzer (Ankom, Macedon, N.Y.) in an assay using amylase but excluding sodium sulfite. The NDF was presented on ash-free basis.

The filtrate samples were analyzed for pH (Accumet™ XL25 pH meter, Fisher Scientific™) and subsequently acidified with 50% H2504 (1% vol/vol), and then centrifuged at 8,000×g for 15 minutes at 4° C. The supernatant was frozen (−20° C.) and analyzed for ammonia by colorimetric N quantification (Technicon™). Volatile fatty acid concentrations (VFA, defined as energy precursors for ruminants as they provide greater than 70% of the ruminant's energy supply) were analyzed by HPLC (Hitachi™ L2400). Briefly, for this test, centrifuged samples were filtered in 1 mL vials and frozen until analysis, 4 mM sulfuric acid was used as mobile phase, and the flow rate was 0.7 mL/min and column temperature was 35° C. using a Bio-Rad Aminex HPX-87H column (Bio-Rad Laboratories™) according to known methods.

The effects of EFE and BsEXLX1 on in vitro dry matter digestibility are summarized in Table 4, below. Adding BsEXLX1 to EFE did not increase hemicellulose digestibility, but compared to the control BsEXLX1 and EFE synergistically (P<0.05) increased digestibility of DM, NDF and ADF by 4.1, 10 and 23.1% in bermudagrass haylage (see Table 3, below). EFE can increase digestibility of fiber from various forages and diets, however this study provides the first evidence that synergistic effects between fibrolytic enzymes and bacterial expansin-like proteins increased forage fiber digestion.

TABLE 3
Effect of BsEXLX1) and EFE on In Vitro True Dry Matter (DMD), Neutral Detergent
Fiber (NDFD), Hemicellulose and Acid Detergent Fiber (ADFD) Digestibility of
Bermudagrass Haylage.

| BsEXLX1 | Control | | EFE | | | P-value | | |
|---|---|---|---|---|---|---|---|---|
| (μg/g DM) | 0 | 162 | 0 | 162 | SEM | EFE | BsEXLX1 | Interaction |
| DMD % | 52.5^{b} | 52.3^{b} | 53.6^{ab} | 54.7^{a} | 1.3 | <0.01 | 0.11 | 0.01 |
| NDFD % | 37.4^{bc} | 36.9^{c} | 39.3^{b} | 41.5^{a} | 2.5 | <0.01 | 0.11 | 0.02 |
| HEMD % | 31.8 | 30.8 | 32.7 | 30.2 | 3.2 | 0.86 | 0.14 | 0.55 |
| ADFD % | 42.9^{c} | 43.1^{c} | 45.9^{b} | 52.8^{a} | 1.9 | <0.01 | <0.01 | <0.01 |

Different lower case letters indicate significant differences (P <0.05); N = 6

Adding BsEXLX1 to EFE synergistically increased NDF and ADF digestibility by 5.5 and 15%, respectively compared to the EFE alone. The NDF fraction includes mainly hemicellulose, cellulose and lignin, whereas the ADF fraction includes only cellulose and lignin. Synergistic effects between cellulases and BsEXLX1 allow increased hydrolysis of cellulose or lignocellulosic substrates, which can explain why ADF digestibility was increased to a greater extent than NDF digestibility.

Total volatile fatty acid concentration (VFA) was synergistically increased by addition of EFE and BsEXLX1 (P<0.05), consequently pH was decreased (see Table 4). Though molar proportions of acetate, butyrate, and isoacids were not affected (P<0.05), that of propionate was synergistically increased (P<0.05) by the adding EFE with BsEXLX1 compared to adding EFE alone (19.2% vs 17.8%). Fibrolytic enzymes can increase the molar proportion of propionate, however the magnitude of the response can depend on the type of enzyme used. Here, dosing with BsEXLX1 alone decreased (P<0.05) molar proportion of acetate and increased the concentration of ammonia (NH₃—N) compared to EFE alone. In contrast, the molar proportion of propionate was increased by adding BsEXLX1 with EFE, consequently the acetate: propionate ratio was synergistically decreased (P<0.05). This likely is due to the greater hydrolysis of cellulose into sugars by the additive combination as high sugar concentrations in the rumen shift the ruminal fermentation pattern towards propionate production.

Synergistic effects between EFE and BsEXLX1 tended to increase the concentration of NH₃—N (see Table 4). Marginal increases in NH₃—N concentrations but larger increases in NDF and ADF digestibility of BMH due to applying an EFE can occur. Here, NDF and ADF digestibility were synergistically increased and NH₃—N tended to be higher when the EFE was applied.

TABLE 4
Effect of BsEXLX1 and EFE on Total VFA and Ammonia Concentrations, Molar
Proportions of Organic Acids, and pH of the Filtrate after In Vitro Fermentation of
Bermudagrass Haylage.

| BsEXLX1 dose | Control | | EFE | | | P-Value | | |
|---|---|---|---|---|---|---|---|---|
| (μg/g of DM) | 0 | 162 | 0 | 162 | SEM | EFE | BsEXLX1 | Interaction |
| Total VFA, | 64.2^{b} | 60.3^{b} | 67.0^{b} | 79.6^{a} | 3.5 | <0.01 | 0.1 | <0.01 |
| mM | | | | | | | | |
| Acetate (A) % | 56.0 | 55.0 | 55.1 | 53.0 | 1.6 | <0.01 | 0.01 | 0.35 |
| Propionate | 17.3^{b} | 17.2^{b} | 17.8^{b} | 19.2^{a} | 0.5 | <0.01 | 0.01 | <0.01 |
| (P), % | | | | | | | | |
| A:P ratio | 3.2^{b} | 3.2^{b} | 3.1^{b} | 2.8^{a} | 0.07 | <0.01 | <0.01 | 0.01 |
| Butyrate, % | 12.9 | 12.8 | 12.6 | 12.3 | 0.4 | 0.16 | 0.46 | 0.64 |
| Valerate, % | 5.7 | 6.4 | 6.3 | 6.7 | 0.5 | 0.35 | 0.20 | 0.76 |
| Isobutyrate, % | 3.4 | 3.6 | 3.3 | 3.6 | 0.8 | 0.86 | 0.09 | 0.71 |
| IsoValerate, % | 4.5 | 4.6 | 4.6 | 4.8 | 0.6 | 0.61 | 0.49 | 0.93 |
| NH₃—N mg/dL | 51.3 | 49.4 | 55.3 | 56.1 | 3.5 | <0.01 | <0.01 | 0.1 |
| pH | 7.01^{b} | 6.98^{a} | 6.98^{a} | 6.97^{a} | 0.02 | <0.01 | <0.01 | 0.04 |

Different letters indicate significant differences (P <0.05); N = 6.

In summary, this study showed that an expansin-like protein synergistically increased the hydrolysis of pure cellulose substrates and the hydrolysis and digestibility in vitro of bermudagrass haylage.

### Example 4. Effect of BsEXLX1 and Fibrolytic Enzymes on In Vitro Digestibility and Preingestive Hydrolysis of Bermudagrass Silage

The objective of these tests was to evaluate if synergistic effects exist between EFE and BsEXLX1 on ruminal in vitro neutral detergent fiber digestibility (NDFD) and preingestive hydrolysis of bermudagrass silage. First, the effects of 2 levels of EFE (0, 2.33 mg/g substrate) and 4 levels of BsEXLX1 (0, 136, 272, 408 μg/g substrate) were tested on bermudagrass silage in a 4×2 factorial arrangement of treatments. Samples were preincubated with EFE and BsEXLX1 using sodium phosphate buffer (pH 6) for 1 hour at room temperature in triplicate and further incubated in rumen fluid media for 24 hours at 39° C. The experiment was repeated 3 times.

Second, synergistic effects of the same levels of EFE and BsEXLX1 on preingestive hydrolysis were examined in quadruplicate by incubating ground bermudagrass silage samples (0.5 g) for 24 hours at 25° C. and measuring DM loss and NDF hydrolysis.

Data were analyzed using the NMLE package of R and the model for E-1 included the fixed effects of EFE, BsEXLX1, run, interactions and the random effect of cow nested within run. The model for E-2 included the fixed effects EFE, BsEXLX1, run, and interactions.

In the first test, DMD and NDFD were increased by 7% (46.9 vs 50.3%, P<0.01) and 3% (35.4 vs 36.4%, P<0.01) by EFE, respectively. However, no interactions or synergistic effects on DMD (49.6, 50.4, 50.6, and 50.4%, P=0.8) and NDFD (36.0, 36.8, 36.6 and 36.0%, P=0.2) were observed when BsEXLX1 was added with EFE. Total VFA was increased by 9% with EFE compared with control (83.7 vs 91.1 mM, P<0.01) and reduced by 5% (87.4 vs 92.3, 86.7 and 83.3 mM, P<0.01) by the highest dose of BsEXLX. For preingestive hydrolysis, compared with the control, EFE increased DM loss and NDF loss by 25% (21.4 vs 26.9%, P<0.01) and 15% (20.9 vs 24.1%, P<0.01), respectively but the expansin had no effect.

In summary, the EFE increased DM and NDF digestibility of bermudagrass silage but the BsEXLX1 did not. The BsEXLX1 dose did not affect DM loss and NDF hydrolysis. The efficacy of the EFE was not improved when various doses of BsEXLX1 were added.

### Example 5. Effects of BsEXLX1 and Fibrolytic Enzyme on In Vitro Nutrient Digestibility and Preingestive Hydrolysis of Alfalfa Silage

The aim of this study was to examine if effects of an exogenous fibrolytic enzyme (EFE) on in vitro digestibility and preingestive hydrolysis of alfalfa silage can be synergistically increased by different doses of BsEXLX1). Treatments were arranged in a 2×4 factorial arrangement with two levels of EFE (0, 2.3 mg/g DM) and four levels of BsEXLX1 (0, 0.106, 0.212, and 0.424 mg/g DM).

First, dried, ground (1 mm) alfalfa silage samples were preincubated in sodium citrate buffer for 1 hour at room temperature in quadruplicate, with or without the treatments, followed by incubation in rumen fluid for 24 hours at 39° C. Gas production (GP), in vitro true digestibility, CH₄ emissions, and VFA profile were measured after 24 hour. Second, alfalfa silage was incubated, with or without the treatments, in deionized water containing 0.02% sodium azide for 24 hours at 25° C. and preingestive hydrolysis was measured. Data were analyzed using NLME package of R studio with EFE, BsEXLX1 and interaction as fixed effects and run as a random factor in the model.

In the first test, EFE increased GP (P=0.02) and reduced pH (P<0.01) compared to the control; however, no effects were observed on in vitro DM, NDF, and ADF digestibility. Similarly, the combination of EFE and BsEXLX1 had no effects on digestibility of DM, NDF, and ADF or VFA and NH3-N concentrations. Methane emissions tended to increase with EFE (P=0.08) treatment while BsEXLX1 supplemented at 0.212 and 0.424 mg/g DM significantly increased CH₄ emissions (P<0.01), compared to the control. During preingestive hydrolysis (test 2), EFE increased DM, NDF, ADF and HEM hydrolysis (P<0.01); however, no synergistic improvements were observed when BsEXLX1 was added. Adding EFE increased release of reducing sugars compared to control (P<0.01) but no effects were observed by adding BsEXLX1 (P=0.80). In conclusion, EFE increased preingestive hydrolysis of alfalfa fiber but adding BsEXLX1 did not synergistically increase the response.

### Example 6. Effects of BsEXLX1 and EFE on Preingestive Fiber Hydrolysis, Fermentation and Digestibility of Corn Silage

The objective was to examine individual and synergistic effects of BsEXLX1 and an EFE on preingestive hydrolysis, in vitro ruminal fermentation and digestion, and sugar profile of whole-plant corn silage. First, the EFE (0, 2.33 mg/g) and expansin (0, 304, 616, 888 μg/g) were incubated with dried ground corn silage (0.50 g; 1 mm) in buffered rumen fluid in quadruplicate for 24 hours at 39° C. in 3 independent runs. Gas production was measured after 0, 3, 6, 12 and 24 hours. Data were analyzed using the NMLE package of R for a randomized block design and run was the blocking factor.

EFE alone increased gas production at 3 hours and 6 hours compared with the control (15.3 vs 17.3 and 16.1 vs 17.8 mL/g DM, P<0.01) and adding the highest dose of expansin tended to increase gas production (22.2 vs 21.6 mL/g DM P=0.09). Adding EFE alone increased NDF digestibility (34.0 vs 32.9% P=0.04) but expansin did not (P=0.45). Total CH4 production and VFA profile were not affected by EFE (P>0.05) or expansin (P>0.05) addition.

Second, a similar approach was used to examine simulated preingestive effects by incubating the corn silage with deionized water containing 0.02% sodium azide in quadruplicate for 24 hours at 25° C. in 2 independent runs. Treatments were arranged in a 2×4 factorial. EFE application increased (P<0.05) DM, NDF and ADF disappearance as well as (P<0.01) concentrations of cellobiose, glucose, xylose, and arabinose, whereas adding expansins alone increased only arabinose concentration (2.1 vs 1.4 mg/ml P<0.01). In conclusion, EFE application alone increased fiber digestibility and sugar release and the highest expansin dose increased gas production, however no synergistic effects of applying both additives on rumen fermentation parameters or fiber digestibility were detected.

In summary, no synergy was observed between BsEXLX1 and EFE on in-vitro nutrient digestibility and preingestive hydrolysis here. Exogenous fibrolytic enzymes were effective in improving nutrient digestibility.

### Example 7. Synergistic Effects of BsEXLX1 a Fibrolytic Enzyme on Digestibility, Gas Production and Sugar Release from Bermudagrass Silage

This study examined the effects of BsEXLX1 and EFE on preingestive hydrolysis, in vitro ruminal fermentation, and sugar profile of bermudagrass silage. First, the effects of 2 levels of EFE (0, 2.33 mg/g) and 4 levels of BsEXLX1 (0, 304, 616, 888 μg/g) were evaluated using an in vitro batch culture of buffered-rumen fluid. Dried ground bermudagrass silage (0.50 g; 1 mm) was used as substrate. Treatments were arranged in a 2×4 factorial using a randomized block design. Samples were incubated for 24 hours at 39° C. in quadruplicate per run in 3 independent runs. Gas production was measured at 0, 3, 6, 12 and 24 hours. Data from both experiments were analyzed using NLME package of R. The model included the effects of EFE, dose and run was used as a blocking factor, repeated statement was used to estimate gas production.

EFE and high dose expansins synergistically increased gas production at 3, 6, 12, and 24 hours compared with EFE only (56.2 vs 54.7 mL/g OM P<0.01). Similarly, synergistic increases in digestibility of DM (47.5 vs 43.9% P=0.04), NDF (33.9 vs 30.7% P=0.08) and ADF (27.3 vs 23.8% P=0.09) were detected. Adding EFE alone increased total VFA concentration (71.4 vs 63.2 mM P<0.01) and decreased total CH4 production while adding expansin alone decreased acetate-to-propionate ratio (2.62 vs 2.67 P<0.02).

Second, the preingestive effects of EFE and expansins were evaluated by incubating the substrate in deionized water containing 0.02% (vol/vol) sodium azide. Samples were incubated for 24 hours at room temperature (25° C.) in quadruplicate in 2 independent runs. EFE and expansins synergistically increased % losses of DM, and NDF, regardless of the expansin dose (P<0.05). Similarly, compared with EFE alone, synergistic increases in release of total reducing sugar (42.5 vs 35.3 mg/g P=0.04) and cellobiose (1.74 vs 1.29 mg/mL P=0.05) were detected. In conclusion, the combination of EFE and expansins synergistically increased NDF hydrolysis and DM and digestibility of bermudagrass silage.

In summary, BsEXLX1 synergistically increased in-vitro fiber digestibility when supplemented with EFE. Similarly, DM and NDF hydrolysis was synergistically increased with the combination of BsEXLX1 and EFE.

### Example 8. Effect of a Dual-Purpose Bacterial Inoculant and BsEXLX1 on the Fermentation Profile and Digestibility of Whole-plant Corn Silage

This study aimed to examine the effects of a dual-purpose bacterial inoculant (DPI) and BsEXLX1 on whole-plant corn silage fermentation and digestibility. The dose of BsEXLX1 was estimated based on endoglucanase (2410 μmol/min/m1) and xylanase (16887 μmol/min/m1) activities in the inoculant. The hydrolytic capacity of DPI and freshly purified BsEXLX1 was examined using filter paper (FP) and oat-spell xylan using four treatments: 1) Control (Distilled water), 2) BsEXLX1 (37 mg/g), 3) DPI (120,000 cfu/g of lactic acid bacteria and Propionibacterium freudenreichii+fibrolytic enzymes) and 4) DPI+BsEXLX1. In addition, whole-plant corn was harvested at 34% DM, ensiled in quadruplicate for 0, 3 and 60 days in 0.7 kg mini-silos after it was sprayed with or without the treatments.

Samples were analyzed for fermentation profile and incubated in quadruplicate to determine 24-hour gas production (GP) and in vitro true DM and NDF digestibility. Hydrolytic capacity data were analyzed with a model that included effects of DPI, BsEXLX1 and the interaction, whereas for corn silage samples, the model included effects of DPI, BsEXLX1, day and interactions. Although, DPI and BsEXLX1 synergistically increased (P<0.01) hydrolysis of FP (7.1 vs 5.5 mg/g), BsEXLX1 decreased hydrolysis of xylan compared to DPI alone (10.3 vs 12.2 mg/g). After 3 days of ensiling, no treatment effects were observed on silage DM, DM recovery, CP concentration or yeast and mold counts (P>0.10) but BsEXLX1 decreased pH (3.94 vs 3.88, P<0.01), compared to the control. After 60 days, lactate concentrations were increased (6.3 vs 8.3% DM, P<0.05) by DPI, whereas BsEXLX1 decreased NDF concentration (47.1 vs 45.1%, P=0.03). Consequently, compared to DPI alone, BsEXLX1 and DPI increased starch concentration (20.4 vs 24.9% DM) and tended to increase (P<0.07) GP (66.2 vs 70.2 mL/g OM), and DMD (48.2 vs 50.2%) but not NDFD (29.6 vs 31.9%) at 60 days. These results suggest that BsEXLX1+DPI increases fermentation and digestibility of whole-plant corn silage.

In summary, the combination of BsEXLX1 and microbial inoculant added during making the corn silage had synergistic effects on improving dry matter digestibility of corn silage.

### Example 9. Identification of BsEXLX1 Homologues in Ruminal Bacterial Genomes

For identification of BsEXLX1 homologues in ruminal bacterial genomes, the DNA of the ligation product (plasmid) encoding the yoaJ gene for expression of BsEXLX1 in E. coli cells was sequenced. The inserted DNA sequence was later translated to an amino acid sequence using ExPASy™ software. The encoded protein BsEXLX1 with ID: WP_003231419, was identified by protein BLAST using the National Center for Biotechnology Information database. The BsEXLX1 protein was compared to proteins in ruminal bacterial genomes using the procedure described in Hackmann et al., Environ. Microbiol. 19:4670-4683, 2017. Briefly, a total 447 rumen bacterial genomes (permanent drafts only) were selected from the literature (see Russell, in Rumen Microbiology and Its Role in Ruminant Nutrition. Russell, J. B, edi. Cornell University, New York, USA, pages 18-22, 2002 and Hackmann et al., Environ. Microbiol. 19:4670-4683, 2017) using the Integrated Microbial Genomes system (IMG/M). Then individual genomes were grouped by family and compared with the BsEXLX1 protein sequence using the BLAST™ protein tool. Similarities are reported in Table 5, below, using the percentage of homology, alignment score (E-value) and amino acid identities.

TABLE 5
Alignment of BsEXLX1 to Similar Proteins in
Ruminal Bacterial Genomes.

| | | Homol- | | AA |
|---|---|---|---|---|
| Family | Species | ogy | E−value¹ | identities |
| Bacillaceae | Bacillus | 84 | 8.0E−146 | 191/228 |
| | licheniformis | | | |
| Ruminococcaceae | Ruminococcus | 42 | 1.0E−52 | 87/209 |
| | flavefaciens | | | |
| Ruminococcaceae | Unknown | 34 | 2.0E−31 | 75/219 |
| Eubacteriaceae | Eubacterium | 37 | 2.0E−31 | 77/210 |
| | xylanophilum | | | |
| Lachnospiraceae | Unknown | 39 | 6.0E−30 | 72/185 |
| Lachnospiraceae | Unknown | 34 | 2.0E−24 | 62/183 |

¹E-value is the probability of a having a better or equal alignment during the Blast process; the lower the value the higher the homology (Fassler and Cooper, 2011).

For the identification of BsEXLX1 homologues in rumen bacterial genomes, the results of the examination of alignments between ruminal bacterial genomes and BsEXLX1 are summarized in Table 5. Similar sequences were identified from families Bacillaceace, Ruminococcaceae, Eubacteriaceae and Lachnospiraceae, however only three bacterial species with similar sequences were found including two fiber-digesting bacteria: Ruminococcus flavefaciens and Eubacterium xylanophilum. The ruminal bacterium Bacillus lincheniformis had a protein with the highest homology (84%) among all identified species based on the alignment score and amino acid identities. BsEXLX1 is found only in B. subtilis, therefore the fact that a similar sequence of expansin-like protein was found in B. licheniformis in this study, is notable. Both B. lincheniformis and B. subtilis have similar chromosomal regions in their genomes, which explains why a similar protein to BsEXLX1 was found in B. licheniformis. Yet, B. subtilis is predominately aerobic, whereas B. lincheniformis is a facultative anaerobe that unlike B. subtilis, can grow in special niches in the gastrointestinal tract, including the rumen. Cellulases and xylanases from B. lincheniformis found in native Korean goats increased cellulose hydrolysis and feeding B. subtilis and B. lincheniformis as probiotics increased milk production and milk fat concentration and yield by sheep. Some homology with BsEXLX1 also was detected among proteins in R. flavefaciens and E. xylanophilum (42% and 37% similarity compared to BsEXLX1), which have been described as xylanolytic. Ruminococcus flavefaciens can produce also endoglucanases as well as hemicellulases.

The sequences found in E. xylanophilum and unidentified Lachnospiraceae strains had more (356 and 422 vs. 232 aa) amino-acids than BsEXLX1, these hypothetical proteins were not similar to expansins or expansin-like proteins previously identified based on their E-value, amino acid identities and relatively low homology with the BsEXLX1 protein. A recent study demonstrated that bacterial expansin-like proteins can be incorporated into the bacterial cellulosomes. These results could explain why amino acid sequences of E. xylanophilum and species in family Lachnospiraceae share some sequence similarity with BsEXLX1 despite having far more amino acids.

### Example 10. Summary of Data

See Tables 6 and 7, below, for summaries of the data reported in the Examples above.

TABLE 6
Examples 1-3 and 8.

| | | | DATA OBTAINED | | | | | |
|---|---|---|---|---|---|---|---|---|
| | | | | | BsEXLX1 | EFE | BsEXLX | |
| Example | Test | Substrate | | Control | Alone | Alone | 1 + EFE | Effects |
| 1 | Confirming | Cotton fiber | Cell wall | 0 | 100 | — | — | BsEXLX1 |
| | disruptive | | extension | | | | | extended |
| | activity of | | (pH 4 and | | | | | cellulose |
| | BsEXLX1 | | 50° C.) | | | | | cell wall |
| | | | | | | | | (FIG. 1) |
| 2 | Validation of | Avicel, | Sugar | — | — | — | — | Combining |
| | synergy with | Cellulose | release mg/g | | | | | BsEXLX1 |
| | pure cellulase | | of substrate | | | | | and |
| | | | (pH 4 and | | | | | cellulase |
| | | | 50° C.) | | | | | synergistically |
| | | | | | | | | increased |
| | | | | | | | | sugar |
| | | | | | | | | release |
| | | | | | | | | compared |
| | | | | | | | | to cellulase |
| | | | | | | | | alone by |
| | | | | | | | | 48.3% after |
| | | | | | | | | 3 hours and |
| | | | | | | | | 28.8% after |
| | | | | | | | | 12 hours |
| 3 | Experiment 1: | Carboxy | Sugar | 4.0 | 4.1 | 46.1 | 49.2 | Synergistic |
| | Combination | methyl | release mg/g | | | | | effects |
| | of BsEXLX1 | cellulose | of substrate | | | | | between |
| | and cellulase | (CMC) | (pH 4 and | | | | | BsEXLX1 |
| | | | 50° C.) | | | | | and |
| | | | | | | | | Cellulase |
| | | | | | | | | observed |
| | | | | | | | | (Table 1) |
| | | | Sugar | 4.1 | 3.6 | 38.8 | 42.2 | Synergistic |
| | | | release mg/g | | | | | effects |
| | | | of substrate | | | | | between |
| | | | (pH 6 and | | | | | BsEXLX1 |
| | | | 39° C.) | | | | | and |
| | | | | | | | | Cellulase |
| | | | | | | | | observed |
| | | | | | | | | (Table 1) |
| | | | Sugar | 3.8 | 3.6 | 37.1 | 39.7 | Synergistic |
| | | | release mg/g | | | | | effects |
| | | | of substrate | | | | | between |
| | | | (pH 6 and | | | | | BsEXLX1 |
| | | | 25° C.) | | | | | and |
| | | | | | | | | Cellulase |
| | | | | | | | | observed |
| | | | | | | | | (Table 1) |
| | | Filter paper | Sugar | 1.3 | 1.3 | 5.7 | 7.6 | Synergistic |
| | | | release mg/g | | | | | effects |
| | | | of substrate | | | | | between |
| | | | (pH 6 and | | | | | BsEXLX1 |
| | | | 39° C.) | | | | | and |
| | | | | | | | | Cellulase |
| | | | | | | | | observed |
| | | | | | | | | (Table 1) |
| | | Oat-spelt | Sugar | 5.8 | 6.2 | 119 | 123 | No synergy |
| | | xylan | release mg/g | | | | | was |
| | | | of substrate | | | | | observed |
| | | | (pH 4 and | | | | | (Table 1) |
| | | | 50° C.) | | | | | |
| | | Oat-spelt | Sugar | 6.1 | 6.3 | 139 | 137 | No synergy |
| | | xylan | release mg/g | | | | | was |
| | | | of substrate | | | | | observed |
| | | | (pH 6 and | | | | | (Table 1) |
| | | | 39° C.) | | | | | |
| | Experiment 2: | BGH | DM | 18.5 | 18.5 | 20.1 | 21.2 | Synergy |
| | Combination | | hydrolysis | | | | | was |
| | of BsEXLX1 | | (%) | | | | | observed on |
| | and | | | | | | | DM |
| | commercial | | | | | | | hydrolysis |
| | EFE | | | | | | | (Table 2) |
| | (Preingestive | | | | | | | |
| | hydrolysis | | | | | | | |
| | (25° C., 1 h) | | | | | | | |
| | Experiment 3: | | DM | 52.5 | 52.3 | 53.6 | 54.7 | Synergy |
| | Combination | BGH | digestibility | | | | | was |
| | of BsEXLX1 | | (%) | | | | | observed on |
| | and | | | | | | | DM |
| | commercial | | | | | | | digestibility |
| | EFE (Invitro | | | | | | | (Table 3) |
| | rumen | | | | | | | |
| | digestibility | | | | | | | |
| | (39° C., 24 h) | | | | | | | |
| 8 | Combination | Whole plant | DM | — | — | — | — | DM |
| | of microbial | corn silage | digestibility | | | | | digestibility |
| | inoculant and | | (%) | | | | | was |
| | BsEXLX1 | | | | | | | synergistically |
| | | | | | | | | improved |
| | | | | | | | | with |
| | | | | | | | | combination |
| | | | | | | | | of |
| | | | | | | | | BsEXLX1 |
| | | | | | | | | and |
| | | | | | | | | microbial |
| | | | | | | | | inoculant |

TABLE 7
Examples 4-7, using two levels of EFE (0, 2.3 mg/g substrate) and 4 levels of
BsEXLX1 (0, 304, 616, 888 μg/g substrate).

| | | | DATA OBTAINED | | | | | | | | |
|---|---|---|---|---|---|---|---|---|---|---|---|
| | | | | Control | | | | EFE | | | |
| Example | Test performed | Substrate | BsEXLX1 | 0 | Dose 1 | Dose 2 | Dose 3 | 0 | Dose 1 | Dose 2 | Dose 3 |
| Example | BsEXLX1 and | Bermudagrass | DM | 21.3 | 21.2 | 21.7 | 21.6 | 26.9 | 27.4 | 27.8 | 25.6 |
| 4§ | commercial EFE | silage | hydrolysis | | | | | | | | |
| | (Preingestive | | (%) | | | | | | | | |
| | hydrolysis (25° C., | | | | | | | | | | |
| | 1 h) | | | | | | | | | | |
| | BsEXLX1 | Bermudagrass | DM | 46.5 | 46.5 | 47.3 | 47.5 | 49.6 | 50.4 | 50.6 | 50.5 |
| | commercial EFE | silage | digestibility | | | | | | | | |
| | (Invitro rumen | | (%) | | | | | | | | |
| | digestibility (39° C., | | | | | | | | | | |
| | 24 h) | | | | | | | | | | |
| Example | BsEXLX1 and | Alfalfa silage | DM | 31.5 | 31.3 | 31.4 | 31.6 | 32.4 | 32.3 | 32.9 | 32.8 |
| 5* | commercial EFE | | hydrolysis | | | | | | | | |
| | (Preingestive | | (%) | | | | | | | | |
| | hydrolysis (25° C., | | | | | | | | | | |
| | 1 h) | | | | | | | | | | |
| | BsEXLX1 and | Alfalfa silage | DM | 57.5 | 59.0 | 59.3 | 59.0 | 59.5 | 58.2 | 59.5 | 59.5 |
| | commercial EFE | | digestibility | | | | | | | | |
| | (Invitro rumen | | (%) | | | | | | | | |
| | digestibility (39° C., | | | | | | | | | | |
| | 24 h) | | | | | | | | | | |
| Example | BsEXLX1 and | Corn silage | DM | 16.1 | 15.3 | 17.3 | 15.7 | 17.3 | 17.6 | 17.0 | 16.1 |
| 6† | commercial EFE | | hydrolysis | | | | | | | | |
| | (Preingestive | | (%) | | | | | | | | |
| | hydrolysis (25° C., | | | | | | | | | | |
| | 1 h) | | | | | | | | | | |
| | BsEXLX1 and | Corn silage | DM | 63.3 | 62.6 | 63.6 | 62.8 | 63.1 | 63.2 | 63.3 | 63.3 |
| | commercial EFE | | digestibility | | | | | | | | |
| | (Invitro rumen | | (%) | | | | | | | | |
| | digestibility (39° C., | | | | | | | | | | |
| | 24 h) | | | | | | | | | | |
| Example | BsEXLX1 and | Bermudagrass | DM | 25.7 | 25.8 | 25.7 | 25.3 | 26.8 | 26.9 | 27.3 | 27.9 |
| 7† | commercial EFE | silage | hydrolysis | | | | | | | | |
| | (Preingestive | | (%) | | | | | | | | |
| | hydrolysis (25° C., | | | | | | | | | | |
| | 1 h) | | | | | | | | | | |
| | BsEXLX1 and | Bermudagrass | DM | 43.4 | 42.9 | 43.3 | 43.9 | 43.9 | 43.9 | 43.6 | 47.5 |
| | commercial EFE | silage | digestibility | | | | | | | | |
| | (Invitro rumen | | | | | | | | | | |
| | digestibility (39° C., | | | | | | | | | | |
| | 24 h) | | | | | | | | | | |

§Example 4: BsEXLX1 dose 1, 2, and 3 were 0, 136, 272, and 408 μg/g substrate, respectively
*Example 5: BsEXLX1 dose 1, 2, and 3 were 0, 106, 212, and 424 μg/g substrate, respectively.
†Example 6, 7: BsEXLX1 dose 1, 2, and 3 were 304, 616, and 888 μg/g substrate, respectively.

### REFERENCES

All references listed below and throughout the specification are hereby incorporated by reference in their entirety.
1. Adesogan, A. T., Z. X. Ma, J. J Romero, and K. G. Arriola. 2014. Ruminant nutrition symposium: Improving cell wall digestion and animal performance with fibrolytic enzymes. J. Anim. Sci. 92:1317-1330.
2. Anderson, K. L., T. G. Nagaraja, J. L. Morrill, T. B. Avery, S. J. Galitzer, and J. E. Boyer. 1987. Ruminal microbial development in conventionally or early-weaned calves. J. Anim. Sci. 64:1215-1226.
3. AOAC International. 2000. Official Methods of Analysis. 17th ed. AOAC Int., Arlington, Va.
5. Arriola, K. G., A. S. Oliveira, Z. X. Ma, I. J. Lean, M. C. Giurcanu, and A. T. Adesogan. 2017. A meta-analysis on the effect of dietary application of exogenous fibrolytic enzymes on the performance of dairy cows. J. Dairy Sci. 100:4513-4527.
6. Artzi, L., E. Morag, M. Shamshoum and E. A. Bayer. 2016. Cellulosomal expansin: functionality and incorporation into the complex. Biotechnol. Biofuels. 9:61.
7. Bach-Knudsen, K. E., and B. W. Li. 1991. Determination of oligosaccharides in protein-rich feedstuffs by gas-liquid chromatography and high-performance liquid chromatography. J. Agric. Food Chem. 39:689-694.
8. Barros, M. E., and J. A., Thomson. 1987. Cloning and expression in Escherichia coli of a cellulase gene from Ruminococcus flavefaciens. J. Bacteriol. 169:1760-1762.
9. Beauchemin, K. A., D. Colombatto, D. P. Morgavi, W. Z. Yang. 2003. Use of exogenous fibrolytic enzymes to improve feed utilization by ruminants. J. Anim. Sci. 81:37-47.
10. Bernard, J. K., J. J. Castro, N. A. Mullis, A. T. Adesogan, J. W. West, and G. Morantes. 2010. Effect of feeding alfalfa hay or Tifton 85 bermudagrass haylage with or without a cellulase enzyme on performance of Holstein cows. J. Dairy Sci. 93:5280-5285.
11. Bradford, M. M. 1976. A rapid and sensitive Method for the quantitation of microgram quantities of protein utilizing the principle of protein-dye binding. Anal. Biochem. 72:248-254.
12. Bunterngsook, B., W. Mhuantong, V. Champreda, A. Thamchaiphenet, and L. Eurwilaichitr. 2014. Identification of novel bacterial expansins and their synergistic actions on cellulose degradation. Bioresour. Technol. 159:64-71.
13. Bunterngsook, B., L. Eurwilaichitr, A. Thamchaipenet, and V. Champreda. 2015. Binding characteristics and synergistic effects of bacterial expansins on cellulosic and hemicellulosic substrates. Bioresour. Technol. 176:129-135.
14. Cervantes, A. A. P., I. Muhammad, C. F. Gonzalez, D. Vyas, and A. T. Adesogan. 2016. Expression and purification of a novel bacterial expansin from Bacillus subtilis that synergistically degrades cellulose with fibrolytic enzymes. J. Anim. Sci. 94:791 supp. 5.
15. Chen, H. 2014. Chemical composition and structure of natural lignocellulose. Pages 25-71 in Biotechnology of lignocellulose. Springer, Netherlands.
16. Chen, I. A., V. M. Markowitz, K. Chu, K. Palaniappan, E. Szeto, M. Pillay, A. Ratner, J. Huang, E. Andersen, M. Huntemann, M. Hadjithomas, K. Tennensen, T. Nielsen, N. Ivanova, and N. Kyrpides. 2017. IMG/M: Integrated genome and metagenome comparative data analysis system. Nucleic Acids Res 45:D507-D516.
17. Colombatto, D., F. L. Mould, M. K. Bhat, and E. Owen. 2003. Use of fibrolytic enzymes to improve the nutritive value of ruminant diets A biochemical and in vitro rumen degradation assessment. Anim. Feed Sci. Technol. 107:201-209.
18. Cosgrove, D. J. 2015. Plant expansins: Diversity and interactions with plant cell walls. Curr. Opin. Plant Biol. 25:162-172.
19. Elghandour, M. M. Y., A. Z. M. Salem, M. Gonzalez-Ronquillo, J. L. Bórquez, H. M. Gado, N. E. Odongo, and C. G. Peñuelas. 2013. Effects of exogenous enzymes on in vitro gas production kinetics and ruminal fermentation of four fibrous feeds. Anim. Feed Sci. Technol. 179:46-53.
20. Flint, H. J., J. Martin, C. A. McPherson, A. S. Daniel, and J. X. Zhang. 1993. A bifunctional enzyme, with separate xylanase and beta (1, 3-1, 4)-glucanase domains, encoded by the xynD gene of Ruminococcus flavefaciens. J. Bacteriol. 175:2943-2951.
21. France, J., and J. Dijkstra. 2005. Volatile fatty acid production. Pages 157-176 in Quantitative aspects of ruminant digestion and metabolism, 2nd ed. J. Dijkstra, J. M. Forbes, and J. France, ed. CABI Publishing, Wallingford, UK.
22. Fassler J, P. Cooper. BLAST Glossary from NCBI bookshelf. 2011 Jul. 14. In: BLAST® Help [Internet]. ncbi.nlm.nih.gov/books/NBK62051/23.
Gasteiger, E., C. Hoogland, A. Gattiker, S. Duvaud, M. R. Wilkins, R. D. Appel, and A. Bairoch. 2005. Protein identification and analysis tools on the ExPASy Server BT.Pages 571-607 in the proteolics protocol handbook. J. M. Walker, ed. Humana Press, Totowa, N.J., USA.
24. Georgelis, N., A. Tabuchi, N. Nikolaidis, and D. J. Cosgrove. 2011. Structure-function analysis of the bacterial expansin EXLX1. J. Biol. Chem. 286:16814-16823.
25. Georgelis, N., N. Nikolaidisa, and D. J. Cosgrove. 2014. Biochemical analysis of expansin-like proteins from microbes. Carbohydr. Polym. 100:17-23.
26. Goering, H. K., and P. J. Van Soest. 1970. Forage fiber analysis (Apparatus, Reagents, Procedures, and Some Applications). Agric. Handbook No. 379. ARS USDA, Washington, D.C.
27. Hackmann, T. J., D. K. Ngugi, J. L. Firkins, and J. Tao. 2017. Genomes of rumen bacteria encode atypical pathways for fermenting hexoses to short-chain fatty acids. Environ. Microbiol. 19:4670-4683.
29. Hague, M. A., K. M. Cho, D. N. Barman, M. K. Kim, and H. D. Yun. 2015. A potential cellulose microfibril swelling enzyme isolated from Bacillus sp. AY8 enhances cellulose hydrolysis. Proc. Biochem. 50:807-815.
30. Jalilvand, G., N. E. Odongo, S. Lopez, A. Naserian, R. Valizadeh, F. E. Shahrodi, E. Kebreab, and J. France. 2008. Effects of different levels of an enzyme mixture on in vitro gas production parameters of contrasting forages. Anim. Feed Sci. Technol. 146:289-301.
31. Kim E. S., H. J. Lee, W. G. Bang, I. G. Choi, and K. H. Kim. 2009. Functional characterization of a bacterial expansin from Bacillus subtilis for enhanced enzymatic hydrolysis of cellulose. Biotechnol. Bioeng. 102:1342-1353.
32. Kritas, S. K., A. Govaris, G. Christodoulopoulos, and A. R. Burriel. 2006. Effect of Bacillus licheniformis and Bacillus subtilis supplementation of ewe's feed on sheep milk production and young lamb mortality. Transbound Emerg. Dis. 53:170-173.
33. Krueger, N. A., and A. T. Adesogan. 2008. Effects of different mixtures of fibrolytic enzymes on digestion and fermentation of bahiagrass hay. Anim. Feed Sci. Technol. 145:84-94.
34. Kumar, R., S. Singh, and O. V. Singh. 2008. Bioconversion of lignocellulosic biomass: Biochemical and molecular perspectives. J. Ind. Microbiol. Biotechnol. 35:377-391.
35. Lenth, R. V. 2016. Least-squares means: The R package lsmeans. J. Stat. Softw. 69:1-33.
36. Lin, H., Q. Shen, J. M. Zhan, Q. Wang, and Y. H. Zhao. 2013. Evaluation of bacterial expansin EXLX1 as a cellulase synergist for the saccharification of lignocellulosic agro-industrial wastes. PLoS One 8:e75022.
37. Liu, X., Y. Ma, and M. Zhang. 2015. Research advances in expansins and expansin-like proteins involved in lignocellulose degradation. Biotechnol. Lett. 37:1541-1551.
38. Lou, J., K. A. Dawson, and H. J. Strobel. 1996. Role of phosphorolytic cleavage in cellobiose and cellodextrin metabolism by the ruminal bacterium Prevotella ruminicola. Appl. Environ. Microbiol. 62:1770-1773.
39. McQueen-Mason, S. J., and D. J. Cosgrove. 1995. Expansin mode of action on cell walls (analysis of wall hydrolysis, stress relaxation, and binding). Plant Phys. 107:87-100.
40. Miller, G. L. 1959. Use of dinitrosalicylic acid reagent for determination of reducing sugar. Anal. Chem. 31:426-428.
41. Miron, J., D. Ben-Ghedalia, and M. Morrison. 2001. Invited review: Adhesion mechanisms of rumen cellulolytic bacteria. J. Dairy Sci. 84:1294-1309.
42. Muck, R. E., and J. T. Dickerson. 1988. Storage temperature effects on proteolysis in alfalfa silage. Trans. ASAE 31:1005-1009.
43. Noel, R. J., and L. G. Hambleton. 1976. Collaborative study of a semiautomated method for the determination of crude protein in animal feeds. Journal-Association Off. Anal. Chem. 59:134-140.
44. Oganesyan, N., I. Ankoudinova, S. Kim, and R. Kim. 2007. Effect of osmotic stressand heat shock in recombinant protein overexpression and crystallization. Prot. Expr. Pur. 52:280-285.
45. Olarte-Lozano, M., M. A. Mendoza-Nunez, N. Pastor, L. Segovia, J. Folch-Mallol, and C. Martinez-Anaya. 2014. PcEx11 a novel acid expansin-like protein from the plant pathogen Pectobacterium carotovorum, binds cell walls differently to BsEXLX1. PLoS One. 9: e95638.
46. Ortowski, A., L. Artzi, P. A. Cazade, M. Gunnoo, E. A. Bayer, and D. Thompson. 2018. On the distinct binding modes of expansin and carbohydrate-binding module proteins on crystalline and nanofibrous cellulose: implications for cellulose degradation by designer cellulosomes. Phys. Chem. Chem. Phys. 20:8278-8293.
47. Pagliai, F. A., C. F. Gonzalez, and G. L. Lorca. 2015. Identification of a ligand binding pocket in LdtR from Liberibacter asiaticus. Front. Microbiol. 6:1-13.
48. Peters, A., U. Meyer, and S. Dänicke. 2015. Effect of exogenous fibrolytic enzymes on performance and blood profile in early and mid-lactation Holstein cows. Anim. Nutr. 1:229-238.
49. Phakachoed, N., W. Suksombat, D. Colombatto, and K. A. Beauchemin. 2013. Use of fibrolytic enzymes additives to enhance in vitro ruminal fermentation of corn silage. Livest. Sci. 157:100-112.
50. Pinheiro, J., D. Bates, S. DebRoy, D. Sarkar, and R. C. Team. 2009. NLME: Linear and nonlinear mixed effects models. R package version 3.1-137.
51. Rey, M. W., P. Ramaiya, B. A. Nelson, S. D. Brody-Karpin, E. J. Zaretsky, M. Tang, P. Olsen, M. Rasmussen, J. Andersen, P. Jorgensen, T. Larsen, A. Soroki, A. Bolotin, A. Lapidus, N. Galleron, S. Ehrlich, and R. Berka. 2004. Complete genome sequence of the industrial bacterium Bacillus licheniformis and comparisons with closely related Bacillus species. Gen. Bio. 5: R77.1-R77.
52. Romero, J. J., M. A. Zarate, K. G. Arriola, C. F. Gonzalez, C. Silva-Sanchez, C. R. Staples, and A. T. Adesogan. 2015. Screening exogenous fibrolytic enzyme preparations for improved in vitro digestibility of bermudagrass haylage. J. Dairy Sci. 98:2555-2567.
53. Romero, J. J., E. G. Macias, Z. X. Ma, R. M. Martins, C. R. Staples, K. A. Beauchemin, and A. T. Adesogan. 2016. Improving the performance of dairy cattle with a xylanase-rich exogenous enzyme preparation. J. Dairy Sci. 99:3486-3496.
54. Rosano, G. L., and E. A. Ceccarelli. 2014. Recombinant protein expression in Escherichia coli: Advances and challenges. Front. Microbiol. 5:1-17.
55. Russell, J. B. 2002. Predominant Ruminal Bacteria and Archaea. Pages 18-22 in Rumen Microbiology and Its Role in Ruminant Nutrition. Russell, J. B, edi. Cornell University, New York, USA.
56. Sambrook, J., E. F. Fritsch, and T. Maniatis. 1989. Molecular Cloning: A laboratory manual. 4th edition, edi. Cold spring harbor lab. Press, New York, USA.
57. Seo, J. K., T. S Park, I. H. Kwon, M. Y. Piao, C. H. Lee and J. K. Ha. 2013. Characterization of cellulolytic and xylanolytic enzymes of Bacillus licheniformis JK7 isolated from the rumen of a native Korean goat. Asian-Australas. J. Anim. Sci. 26:50-58.
58. Shi, Y., and P. J. Weimer. 1992. Response surface analysis of the effects of pH and dilution rate on Ruminococcus flavefaciens FD-1 in cellulose-fed continuous culture. Appl. Environ. Microbiol. 58:2583-2591.
59. Silveira, R. L., and M. S. Skaf. 2016. Molecular dynamics of the Bacillus subtilis expansin EXLX1: Interaction with substrates and structural basis of the lack of activity of mutants. Phys. Chem. Chem. Phys. 18:3510-3521.
60. Singh, A., V. Upadhyay, A. K. Upadhyay, S. M. Singh, and A. K. Panda. 2015. Protein recovery from inclusion bodies of Escherichia coli using mild solubilization process. Micro. Cell Fac. 14:1-10.
61. Tovar-Herrera, 0. E., R. A. Batista-Garcia, M. D. R. Sanchez-Carbente, M. M. Iracheta-Cardenas, K. Arévalo-Niño, and J. L. Folch-Mallol. 2015. A novel expansin protein from the white-rot fungus Schizophyllum commune. PLoS One. 10:1-17.
62. Van Gylswyk, N. O., and J. J. T. K., Van der Toorn. 1985. Eubacterium uniforme sp. nov. Eubacterium xylanophilum sp. nov., fiber-digesting bacteria from the rumina of sheep fed corn stover. Int. J. Syst. Evol. Microbiol. 35:323-326.
63. Van Soest, P. J., J. B. Robertson, and B. A. Lewis. 1991. Methods for dietary fiber, neutral detergent fiber and non-starch polysaccharides in relation to animal nutrition. J. Dairy Sci. 74:3583-3597.
64. Wang W. C., C. Liu, Y. Y. Ma, X. W. Liu, K. Zhang, M. H. Zhang. 2014. Improved production of two expansin-like proteins in Pichia pastoris and investigation of their functional properties. Biochem. Eng. J. 84:16-27.
65. Warner, C. D., G. Camci-Unal, N. L. B. Pohl, C. Ford, and P. J. Reilly. 2013. Substrate binding by the catalytic domain and carbohydrate binding module of Ruminococcus flavefaciens fd-1 xyloglucanase/endoglucanase. Ind. Eng. Chem. Res. 52:30-36.
66. Wood, T. M., and K. M. Bhat. 1988. Methods for measuring cellulase activities. Pages 87-112 in Methods in Enzymology. W. A. Wood, and S. T. Kellogg, ed. Vol. 160. Academic Press. London, UK.
67. Yennawar, N. H., L. C. Li, D. M. Dudzinski, A. Tabuchi, and D. J. Cosgrove. 2006. Crystal structure and activities of EXPB1 (Zea M 1), a beta-expansin and group-1 pollen allergen from maize. Proc. Natl. Acad. Sci. U.S.A 103:14664-14671.
68. Zhao, X., L. Zhang, and D. Liu. 2012. Biomass recalcitrance. Part I: the chemical compositions and physical structures affecting the enzymatic hydrolysis of lignocellulose. Biofuel Bioprod. Biorefin. 6:465-482.

What is claimed is:

1. A method of increasing the digestibility of forage for animal feed, comprising contacting the forage with an exogenous fibrolytic enzyme (EFE) and an expansin-like protein.

2. The method of claim 1, wherein the expansin-like protein is a polypeptide comprising expansin activity and at least 80%, 85%, 90%, 91%, 92%, 93%, 94%, 95%, 96%, 97%, 98% or 99% sequence identity to the amino acid sequence of SEQ ID NO: 3.

3. The method of claim 1 or 2, wherein the expansin-like protein comprises SEQ ID NO:3.

4. The method of any of claims 1-3, wherein the forage comprises at least one selected from the group consisting of corn silage, bermudagrass haylage, bermudagrass hay, alfalfa silage, and alfalfa hay.

5. The method of any of claims 1-4, wherein the EFE comprises one or more enzymes selected from the group consisting of cellulase, ligninase, beta-glucosidase, hemicellulase, xylanase, alpha amylase, amyloglucosidase, pectate lyase, cutinase, lipase, keratinase, maltogenic alpha-amylase, and pectolyase.

6. The method of any of claims 1-5, wherein the EFE comprises cellulase or hemicellulase or both.

7. A composition comprising an amount of an EFE and an amount of an expansin-like protein, and optionally a botanically acceptable carrier.

8. The composition of claim 7, wherein the expansin-like protein is a polypeptide comprising expansin activity and at least 80%, 85%, 90%, 91%, 92%, 93%, 94%, 95%, 96%, 97%, 98% or 99% sequence identity to the amino acid sequence of SEQ ID NO: 3.

9. The composition of claim 7 or 8, wherein the expansin-like protein comprises SEQ ID NO:3.

10. The composition of any of claims 7-9, wherein the EFE comprises one or more enzymes selected from the group consisting of cellulase, ligninase, beta-glucosidase, hemicellulase, xylanase, alpha amylase, amyloglucosidase, pectate lyase, cutinase, lipase, keratinase, maltogenic alpha-amylase, and pectolyase.

11. The composition of claim 10, wherein the EFE comprises cellulase or hemicellulase or both.
